(19) United States
(12) Patent Application Publication
(10) Pub. No.: US 2017/0051538 A1
(43) Pub. Date: Feb. 23, 2017

(54) FUNCTION EXTENSION DEVICE AND ELECTRONIC DEVICE FIXING METHOD

(71) Applicant: FUJITSU LIMITED, Kawasaki-shi (JP)

(72) Inventors: Yuta Kobayashi, Yokohama (JP); Sonomasa Kobayashi, Kawasaki (JP)

(73) Assignee: FUJITSU LIMITED, Kawasaki-shi (JP)

(21) Appl. No.: 15/212,391

(22) Filed: Jul. 18, 2016

(30) Foreign Application Priority Data
Aug. 18, 2015 (JP) 2015-161347

(51) Int. Cl. E05B 73/00; A47B 23/04; G06F 1/16

(52) U.S. Cl. CPC E05B 73/0082; G06F 1/1632; G06F 1/1626; A47B 23/04

(57) ABSTRACT

A sliding member locks to hold a tablet type terminal so as not to be removed when the tablet type terminal is connected and releases the lock such that the tablet type terminal is removed in response to first operation. A locking part restricts release of the lock of the sliding member in a state in which the tablet type terminal is connected in response to second operation. A screw protecting member prevents contact with a fixing screw which fixes the locking part in a locked state by the sliding member.

### CROSS-REFERENCE TO RELATED APPLICATION

This application is based upon and claims the benefit of priority of the prior Japanese Patent Application No. 2015-161347, filed on Aug. 18, 2015, the entire contents of which are incorporated herein by reference.

### FIELD

The embodiment discussed herein is related to a function extension device and an electronic device fixing method.

### BACKGROUND

Recently, an information processing device is further downsized and various simple devices easy to carry such as a table type terminal and a compact notebook PC (personal computer) are provided. In such tablet type terminal and notebook PC, various functions are often omitted in order to realize a compact size; there are many models without an extension connector, for example.

Therefore, there is the tablet type terminal and the notebook PC to which a docking station is provided as a function extension device for extending the functions. The docking station is a device to which the tablet type terminal and the notebook PC are connected for providing a keyboard and other extension connectors to the connected devices. Among the docking stations, the one supporting the tablet type terminal is sometimes referred to as a “cradle” and the one supporting the notebook PC is sometimes referred to as a “port replicator”. They are hereinafter collectively referred to as the docking stations.

The information processing device connected to the docking station is fixed such that the connection is maintained by a claw and the like. However, in order to take advantage of portability of the compact information processing device, it is designed such that the information processing device is easily removed from the docking station.

Such compact information processing device is supposed to be displayed or put on store shelves in a state of being connected to the docking station to be used by a client. In such a case, since the information processing device is easily removed from the docking station and the information processing device itself is compact, there is a risk that the information processing device is removed from the docking station to be taken away without permission. There also is a risk that the information processing device is taken away together with the docking station.

Therefore, there is a case in which a mechanism for preventing the docking station and the information processing device from being taken away is provided when the information processing device connected to the docking station is left out of sight. For example, a security slot meeting Kensington standards is often provided on the information processing device and peripheral devices thereof. Herein, an antitheft mechanism using the Kensington slot is referred to as a “Kensington lock”. The Kensington lock includes a wire which may be fixed to an unremovable object. The Kensington lock inserted into the slot and rotated by 90 degrees is be removed from the slot, so that this prevents the device on which the Kensington lock is mounted from being stolen from a place at which the wire is fixed. There is conventional technology similar to the Kensington lock to inhibit movement of a latch member which is inserted into a hole and rotated by 90 degrees, thereby preventing a shutter covering a storage medium from opening, for example.

However, when the Kensington lock is attached to both the docking station and the information processing device, cables for the Kensington locks extend from both of them. In such a state, the cable of the Kensington lock which fixes the information processing device is visible from front, so that this is out of shape. Especially, in the case of the information processing device which is wanted to be made compact, it is difficult to arrange the Kensington slot in a thickness direction and it is difficult to hide the cable as seen from front. Therefore, as the technology of reducing the number of security cables, there is conventional technology to disable rotation of a lever for disengaging a hook of the port replicator which engages with an electronic device by locking the port replicator.

Meanwhile, there is the conventional technology which covers a screw of a case covering the electronic device with a plate to make the case unopenable as antitheft technology regarding the information processing device.

Patent Literature 1: Japanese Laid-open Patent Publication No. 2008-65437

Patent Literature 2: Japanese Laid-open Patent Publication No. 2009-26234

Patent Literature 3: Japanese Laid-open Patent Publication No. 01-244088

However, when the conventional technology of preventing the information processing device from being removed is used on the docking station side, if the docking station is disassembled or broken and the locking mechanism becomes accessible, the locking mechanism may be removed. Therefore, there is a risk that the locking mechanism is easily removed and the information processing device is taken away.

When the conventional technology to cover the screw is used, the screw is covered at times other than locked time, so that there is a disadvantage in operation such as maintenance in a state in which there is no danger of being taken away. There is operation to remove covering, so that the operation such as maintenance becomes complicated.

### SUMMARY

According to an aspect of an embodiment, a function extension device includes: a holding unit that locks to hold an electronic device so as not to be removed when the electronic device is connected and releases the lock such that the electronic device is removed in response to first operation; a release restricting unit that restricts release of the lock of the holding unit in a state in which the electronic device is connected in response to second operation; and a preventing unit that prevents contact with a fixing member that fixes the release restricting unit in a locked state by the holding unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a front perspective view of a state in which a tablet type terminal is connected to a docking station according to an embodiment;

FIG. 2 is a rear perspective view of the state in which the tablet type terminal is connected to the docking station according to the embodiment;

FIG. 3 is a perspective view of an upper surface side of the docking station according to the embodiment;

FIG. 4 is a perspective view of a bottom surface side of the docking station according to the embodiment;

FIG. 5 is a perspective view of an internal structure of the docking station according to the embodiment;

FIG. 6 is a view illustrating an area 100 in FIG. 5 in a state in which the tablet type terminal is not connected;

FIG. 7 is a view illustrating the area 100 in FIG. 5 in a state in which the tablet type terminal is connected;

FIG. 8 is a view illustrating the area 100 in FIG. 5 in a state in which an antitheft lock is fastened; and

FIG. 9 is a flowchart of operation of an antitheft locking mechanism in the docking station according to the embodiment.

### DESCRIPTION OF EMBODIMENT

Preferred embodiments of the present invention will be explained with reference to accompanying drawings. Meanwhile, the function extension device and the electronic device fixing method disclosed in the present application are not limited by the following embodiment.

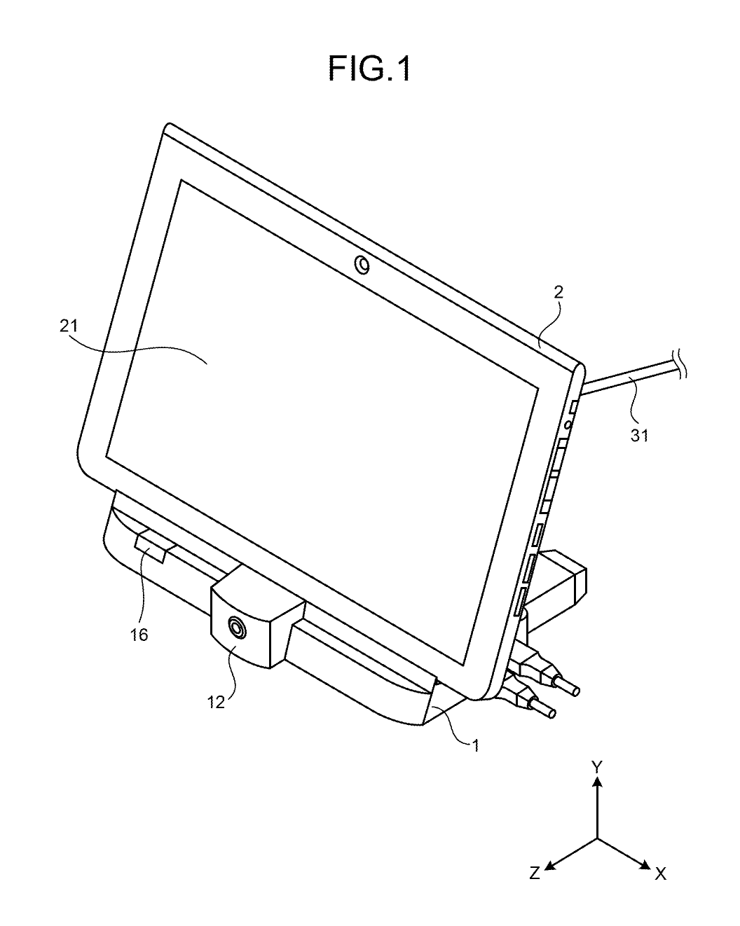

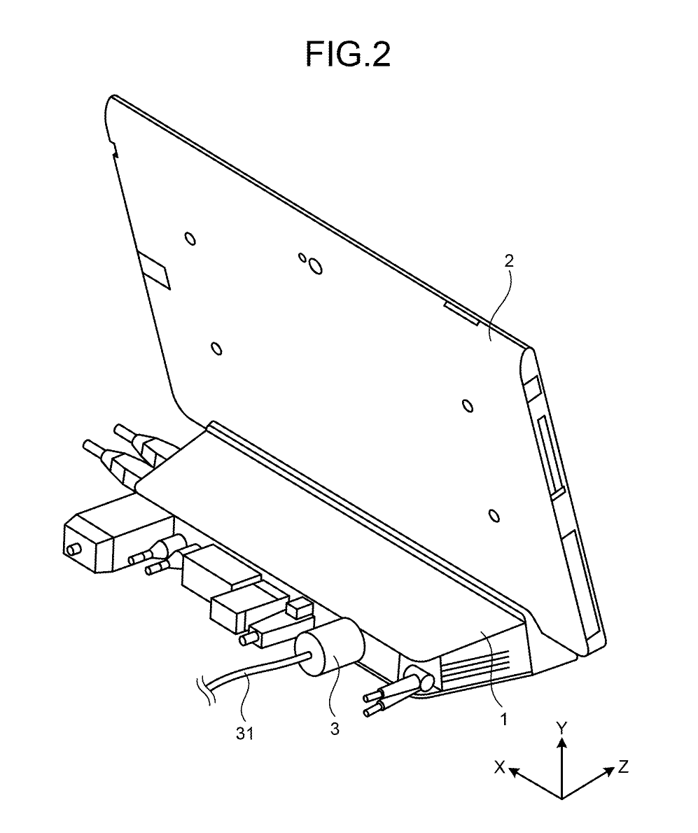

FIG. 1 is a front perspective view of a state in which a tablet type terminal is connected to a docking station according to the embodiment. FIG. 2 is a rear perspective view of the state in which the tablet type terminal is connected to the docking station according to the embodiment.

Herein, a direction indicated by an arrow on an X-axis in each drawing is referred to as an “X direction” and a direction opposite to the direction indicated by the arrow on the X-axis is referred to as an “opposite X direction” in the following description. A direction indicated by an arrow on a Y-axis in each drawing is referred to as a “Y direction” and a direction opposite to the direction indicated by the arrow on the Y-axis is referred to as an “opposite Y direction”. Furthermore, a direction indicated by an arrow on a Z-axis in each drawing is referred to as a “Z direction” and a direction opposite to the direction indicated by the arrow on the Z-axis is referred to as an “opposite Z direction”.

A side of a liquid crystal screen 21 of a tablet type terminal 2 in the state in which the tablet type terminal 2 is connected to a docking station 1 is hereinafter referred to as a “front surface”. That is to say, the opposite Z direction is the direction toward the front surface of the docking station 1 in FIGS. 1 and 2. On the other hand, a side of a surface opposite to the liquid crystal screen 21 of the tablet type terminal 2 in the state in which the tablet type terminal 2 is connected to the docking station 1 is referred to as a “rear surface”. That is to say, the Z direction is the direction toward the rear surface of the docking station 1 in FIGS. 1 and 2. Furthermore, both end faces in the X direction and the opposite X direction of the docking station 1 are referred to as “side surfaces”.

In FIGS. 1 and 2, the tablet type terminal 2 is connected to the docking station 1. A key receiver 12 is provided on the front surface of the docking station 1. The docking station 1 includes extension connector for connecting a network, a printer, a keyboard, a mouse and the like, for example, on the rear surface and the side surfaces thereof.

Furthermore, the docking station 1 includes a slot meeting the Kensington's standards not illustrated on the rear surface thereof, for example. A Kensington lock 3 is inserted into the slot on the rear surface of the docking station 1 to be fastened as illustrated in FIG. 2. The Kensington lock 3 includes a wire 31. The wire 31 is connected to other fixed object. The Kensington lock 3 including the wire 31 connected to the fixed object is an antitheft mechanism of the docking station 1.

The tablet type terminal 2 may utilize an extended function by using the device and the network connected to various extension connectors of the docking station 1. The tablet type terminal 2 corresponds to an example of the “electronic device”.

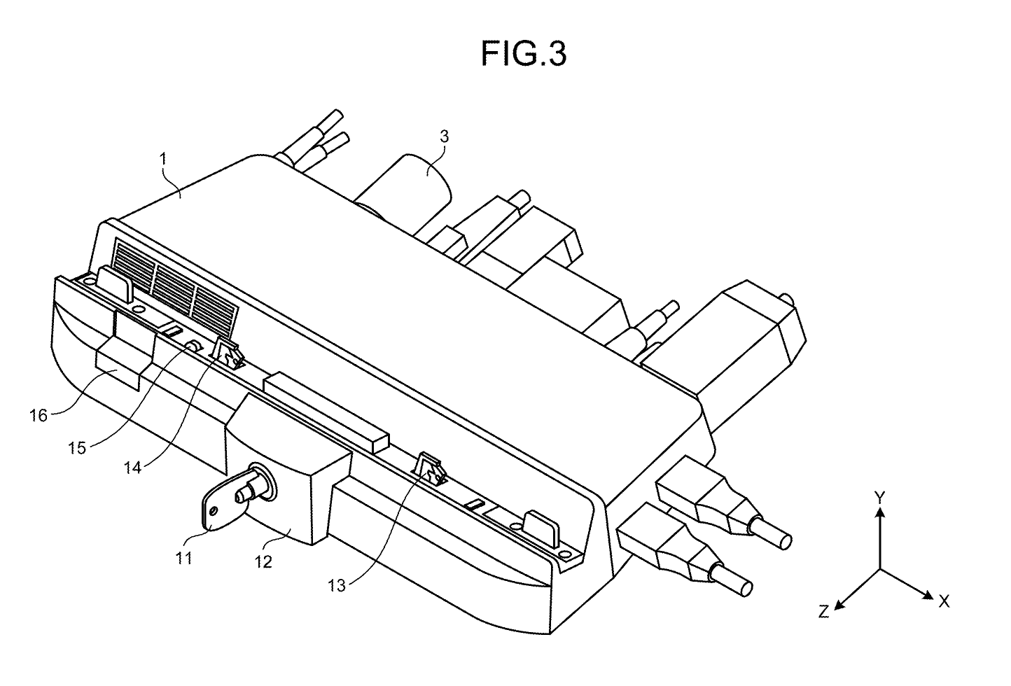

FIG. 3 is a perspective view of an upper surface side of the docking station according to the embodiment. Herein, a surface of the docking station 1 in the Y direction in FIG. 1 is referred to as the upper surface. As illustrated in FIG. 3, the docking station 1 includes the key receiver 12, fixing hooks 13 and 14, a fixing button 15, and a releasing button 16.

The key receiver 12 includes a key hole into which a key 11 is inserted. An antitheft locking mechanism for restricting movement of the fixing hooks 13 and 14 as described later is arranged on the back of the key receiver 12, that is to say, inside the docking station 1. FIG. 3 illustrates a state in which the key 11 is inserted into the key hole of the key receiver 12.

Turning the key 11 inserted into the key hole of the key receiver 12 fastens antitheft lock as described later. Turning the key 11 corresponds to an example of “second operation”.

The fixing hooks 13 and 14 are inserted into locking holes not illustrated provided on the tablet type terminal 2. Hereinafter, positions of the fixing hooks 13 and 14 in which the fixing hooks 13 and 14 may be inserted into and removed from the locking holes of the tablet type terminal 2 without colliding with them are referred to as lock releasing positions. The fixing button 15 to be described later is pressed and the fixing hooks 13 and 14 slide from the lock releasing positions in the X direction to engage with the locking holes of the tablet type terminal 2. According to this, the fixing hooks 13 and 14 lock such that the connected tablet type terminal 2 is not removed from the docking station 1. Hereinafter, a state in which the fixing hooks 13 and 14 engage with the locking holes of the tablet type terminal 2 is referred to as a state in which the tablet type terminal 2 is fixed. The fixing hooks 13 and 14 correspond to an example of “locking claws”.

The fixing button 15 is the button for fixing the tablet type terminal 2 to the docking station 1. The fixing button 15 is pressed in the opposite Y direction by an end opposed to the docking station 1 of the tablet type terminal 2 when the tablet type terminal 2 is connected to the docking station 1. When the fixing button 15 is pressed, the fixing hooks 13 and 14 located in the lock releasing positions in a state of being inserted into the locking holes of the tablet type terminal 2 slide in the X direction to engage with the locking holes.

The releasing button 16 is the button for disengaging the fixing hooks 13 and 14 from the locking holes of the tablet type terminal 2, thereby releasing fixing of the tablet type terminal 2 to put the same into a state removable from the docking station 1. When the releasing button 16 is pressed in the state in which the fixing hooks 13 and 14 engage with the locking holes of the tablet type terminal 2, the fixing hooks 13 and 14 slide in the opposite X direction to move to the lock releasing positions and they are disengaged from the locking holes of the tablet type terminal 2. Pressing the releasing button 16 corresponds to an example of “first operation”.

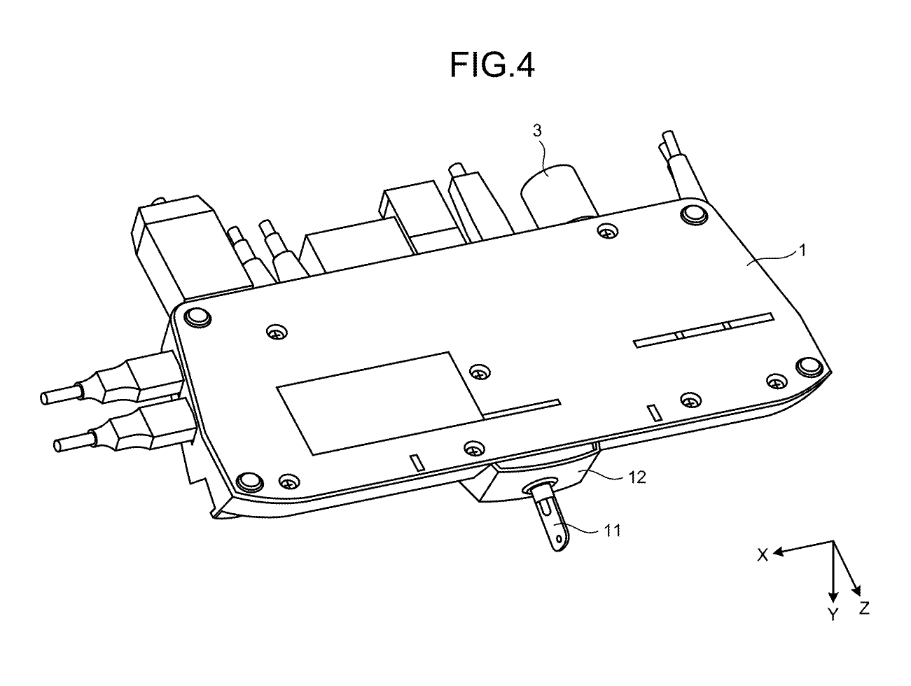

FIG. 4 is a perspective view of a bottom surface side of the docking station according to the embodiment. Herein, a surface of the docking station 1 in the opposite Y direction in FIG. 1 is referred to as the bottom surface. FIG. 4 illustrates the state in which the key 11 is inserted into the key hole of the key receiver 12.

As illustrated in FIG. 4, the docking station 1 is screwed shut on the bottom surface side, so that it is not possible to access inside thereof unless disassembling the same with a screwdriver or braking a housing thereof. However, the docking station 1 may be easily disassembled with the screwdriver and the housing with low strength may be broken with small force.

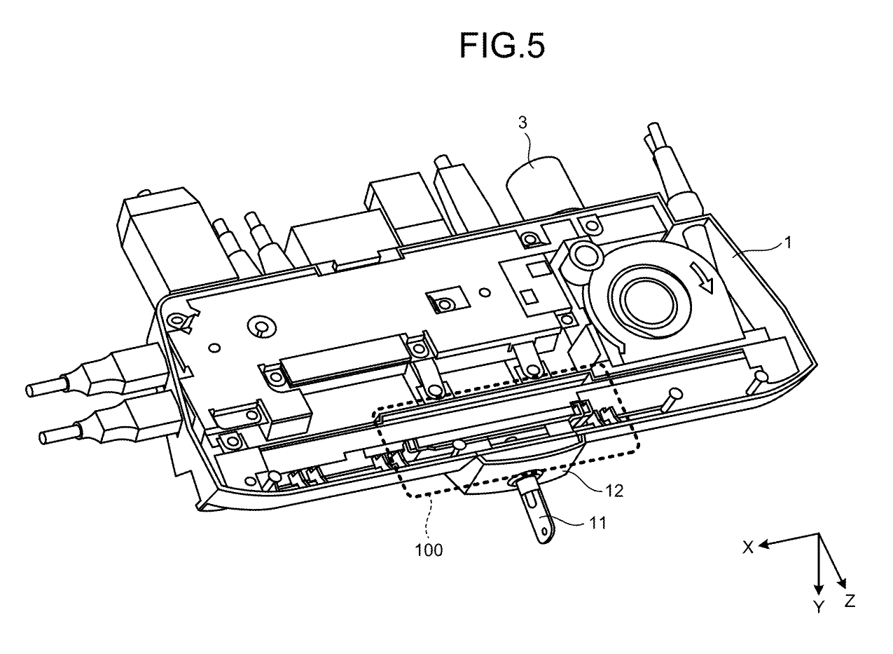

FIG. 5 is a perspective view illustrating an internal structure of the docking station according to the embodiment. FIG. 5 illustrates a state in which the screw on the bottom surface side of the docking station 1 is removed and the housing on the bottom surface is removed in the state in FIG. 4. A substrate to which the various extension connectors are attached is arranged in the docking station 1. A fan for cooling the substrate is also attached in the docking station 1. Furthermore, the antitheft locking mechanism is arranged in the docking station 1 on the back of the key receiver 12, that is to say, in an area 100 enclosed by a broken line.

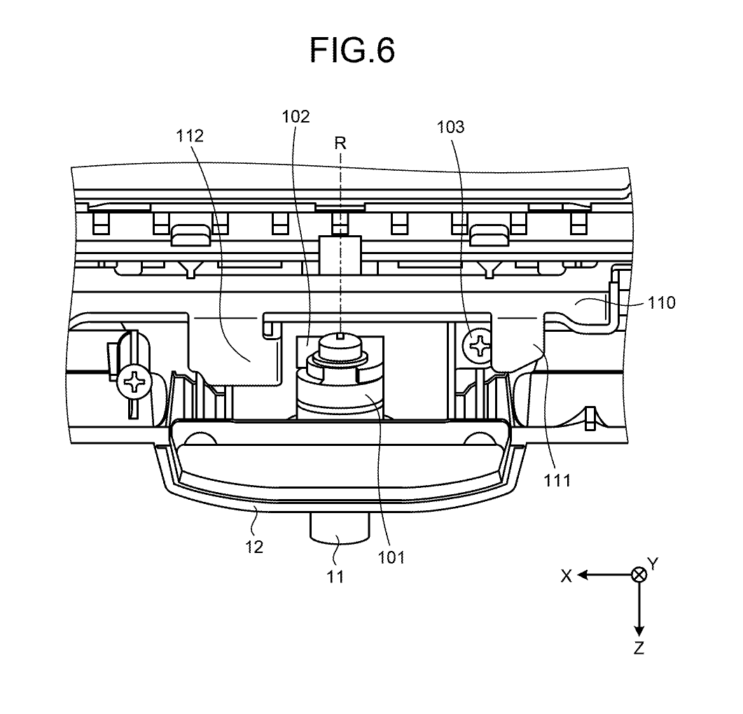

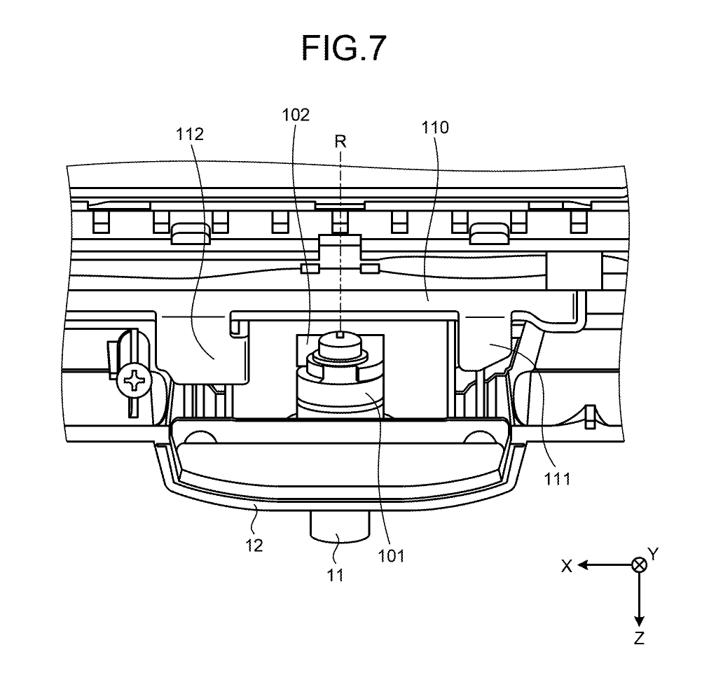

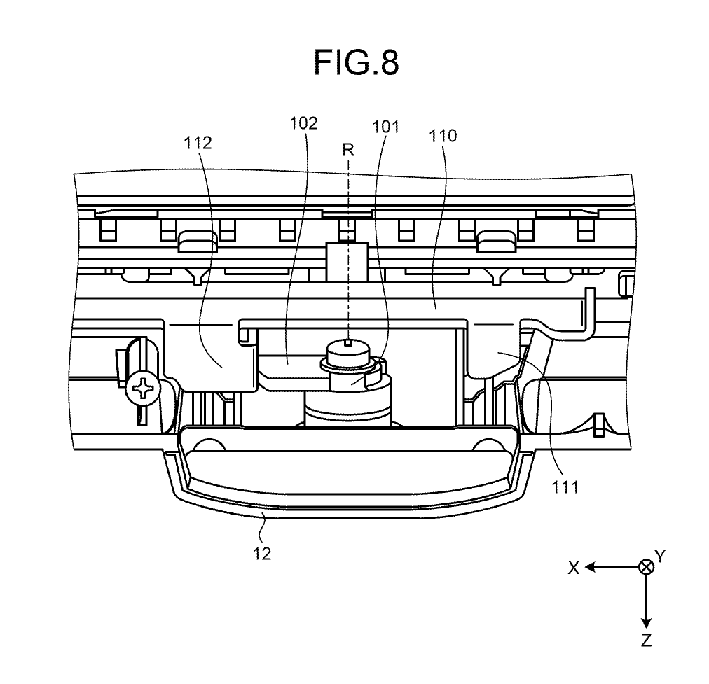

FIG. 6 is a view illustrating the area 100 in FIG. 5 in a state in which the tablet type terminal is not connected. FIG. 7 is a view illustrating the area 100 in FIG. 5 in the state in which the tablet type terminal is connected. FIG. 8 is a view illustrating the area 100 in FIG. 5 in a state in which the antitheft lock is fastened. Hereinafter, each member in the area 100 is first described.

A fixing screw 103 is the screw for fixing the antitheft locking mechanism to the housing of the docking station 1. The antitheft locking mechanism is fixed to the housing of the docking station 1 with a plurality of screws; the antitheft locking mechanism is not removed from the housing of the docking station 1 unless at least the fixing screw 103 is removed.

A sliding member 110 is formed of metal. The sliding member 110 has a shape extending in the X direction and includes the fixing hooks 13 and 14 projecting in the Y direction not illustrated in FIGS. 6 to 8. That is to say, when the sliding member 110 slides in the X direction or the opposite X direction, the fixing hooks 13 and 14 slide. Furthermore, the sliding member 110 includes a screw protecting member 111 and a locking plate receiving member 112. The sliding member 110 corresponds to an example of a “holding unit”.

The screw protecting member 111 is also formed of metal. When the sliding member 110 slides, the screw protecting member 111 slides together with the fixing hooks 13 and 14. The screw protecting member 111 is located in a place away from a position to cover the fixing screw 103 when the fixing hooks 13 and 14 are in the lock releasing positions. Then, in the state in which the fixing hooks 13 and 14 engage with the locking holes of the tablet type terminal 2, the screw protecting member 111 is located in a place to cover the fixing screw 103. The screw protecting member 111 is formed of metal, so that this may certainly prevent access from outside to the fixing screw 103 by covering the fixing screw 103. The screw protecting member 111 corresponds to an example of a “preventing unit”.

The locking plate receiving member 112 is a region which is brought into contact with a locking plate 102 to be described later to stop the sliding of the sliding member 110 when the antitheft lock is fastened. The locking plate receiving member 112 includes a plate member including a surface on an XZ plane projecting from the sliding member 110 in the Z direction. Furthermore, the locking plate receiving member 112 in which an end on a side of the antitheft locking mechanism of the plate member in an XZ plane direction is bent in the Y direction at right angle includes a contact surface with the locking plate 102 on a YZ plane orthogonal to a sliding direction of the sliding member 110. The contact surface with the locking plate 102 of the locking plate receiving member 112 is located in a place opposed to the locking plate 102 when the antitheft lock is fastened.

The antitheft locking mechanism includes the key receiver 12 and a locking part 101. The locking part 101 includes the locking plate 102 projecting in an XY plane direction.

The locking part 101 is coupled to the key hole of the key receiver 12. When the key 11 inserted into the key receiver 12 is turned, the locking part 101 rotates about a rotary axis R. The locking part 101 corresponds to an example of a “release restricting unit”.

The locking part 101 rotates about the rotary axis R, and according to this, the locking plate 102 rotates on the XY plane. Then, the antitheft lock is fastened in a state in which an end in a longitudinal direction of the locking plate 102 is located in a place opposed to the locking plate receiving member 112. When the releasing button 16 is pressed in this state, the locking plate 102 is brought into contact with the locking plate receiving member 112 to prevent the sliding member 110 from sliding. According to this, the fixing hooks 13 and 14 maintain the state of being engaged with the locking holes of the tablet type terminal 2. Therefore, the state in which the tablet type terminal 2 is fixed to the docking station 1 is maintained. The locking plate 102 corresponds to an example of a “restricting member”.

The locking plate 102 is such that the longitudinal direction thereof is a direction toward the locking plate receiving member 112 in the state in which the antitheft lock is fastened. That is to say, when the sliding member 110 slides, the locking plate 102 is subjected to force to disengage the fixing hooks 13 and 14 from the locking holes of the tablet type terminal 2 in the longitudinal direction from the end which is in contact with the locking plate receiving member 112. Since the locking plate 102 is subjected to the force in the longitudinal direction in this manner, this has high strength against the force to disengage the fixing hooks 13 and 14 from the locking holes of the tablet type terminal 2. Therefore, even when the sliding member 110 is forcedly slid, the locking plate 102 is not easily broken and the state in which the antitheft lock is fastened may be maintained.

On the other hand, the conventional antitheft lock is subjected to the force to disengage the fixing hooks 13 and 14 from the locking holes of the tablet type terminal 2 in a thickness direction of the plate-shaped locking plate 102. Therefore, the conventional antitheft lock is often broken by the force to disengage the fixing hooks 13 and 14 from the locking holes of the tablet type terminal 2. In this manner, the antitheft locking mechanism according to this embodiment is less likely to be broken as compared to the conventional antitheft lock, so that it is possible to more certainly prevent the tablet type terminal 2 from being taken away.

Next, operation of the antitheft locking mechanism is collectively described with reference to FIGS. 6 to 8. FIG. 6 illustrates the state in which the tablet type terminal 2 is not connected, so that the fixing hooks 13 and 14 are in the lock releasing positions. As described above, the screw protecting member 111 is located in the place away from the position to cover the fixing screw 103 in the state in which the fixing hooks 13 and 14 are in the lock releasing positions. That is to say, in the state in which the tablet type terminal 2 is not connected, the fixing screw 103 may be removed with the screwdriver and the like.

FIG. 6 illustrates the state in which the key 11 is not turned and the longitudinal direction of the locking plate 102 is the Y direction. In the state in FIG. 6, even when the key 11 is to be rotated, the locking plate 102 is brought into contact with the sliding member 110, so that this is not rotatable.

When the tablet type terminal 2 is connected to the docking station 1 in the state in FIG. 6, the fixing button 15 is pressed by the tablet type terminal 2 and the sliding member 110 slides in the X direction to realize the state illustrated in FIG. 7. In this case, when the sliding member 110 slides in the X direction, the fixing hooks 13 and 14 slide from the lock releasing positions to engage with the locking holes of the tablet type terminal 2.

When the sliding member 110 slides in the X direction, the screw protecting member 111 moves to the position to cover the fixing screw 103 as illustrated in FIG. 7. In FIG. 7, the screw protecting member 111 covers the fixing screw 103, so that the fixing screw 103 is not visible. According to this, the fixing screw 103 is put into a state of rejecting the access. That is to say, in the state in FIG. 7, it is difficult to remove the fixing screw 103 with the screwdriver to remove the antitheft locking mechanism from the housing of the docking station 1.

However, in this state, although the tablet type terminal 2 is fixed to the docking station 1, the antitheft lock is not activated, so that when the releasing button 16 is pressed, the sliding member 110 slides in the opposite X direction, the fixing hooks 13 and 14 move to the lock releasing positions, and the fixing hooks 13 and 14 are disengaged from the locking holes of the tablet type terminal 2. In this manner, in the state in FIG. 7, the fixing of the tablet type terminal 2 is easily released.

Then, the key 11 is turned from the state in FIG. 7 and when the locking plate 102 rotates to move to the position in which this extends in the X direction, the state in which the antitheft lock is fastened illustrated in FIG. 8 is realized. In the state in FIG. 8, a surface of the end in the longitudinal direction of the locking plate 102 is located in the place opposed to the contact surface of the locking plate receiving member 112. When the releasing button 16 is pressed in this state, the sliding member 110 starts sliding in the opposite X direction, and the locking plate receiving member 112 is brought into contact with the end of the locking plate 102 in the opposite X direction being the sliding direction. Therefore, the sliding of the sliding member 110 is restricted and the state in which the fixing hooks 13 and 14 engage with the locking holes of the tablet type terminal 2 is maintained, so that the tablet type terminal 2 is not removed from the docking station 1.

The locking plate 102 is put into a state in which the direction from the rotary axis R in the X direction, that is to say, the direction toward the locking plate receiving member 112 is the longitudinal direction in the state in which the antitheft lock is fastened. According to this, as described above, the locking plate 102 has the high strength against the force to disengage the fixing hooks 13 and 14 from the locking holes of the tablet type terminal 2.

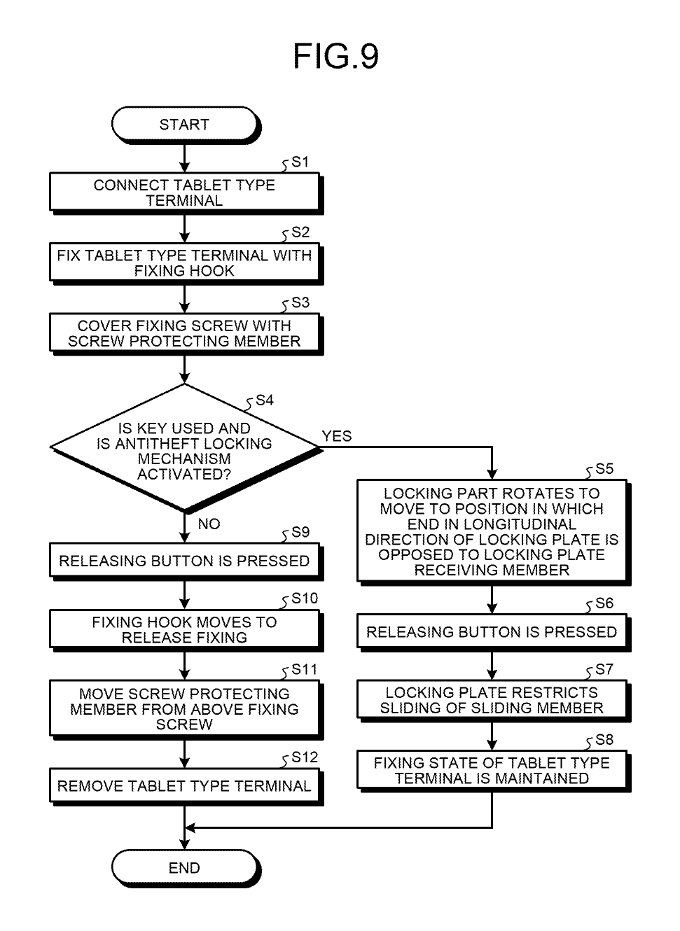

A flow of the operation of the antitheft locking mechanism in the docking station 1 according to the embodiment is next described with reference to FIG. 9. FIG. 9 is a flowchart of the operation of the antitheft locking mechanism in the docking station according to the embodiment.

The tablet type terminal 2 is inserted into the docking station 1 to be connected to the docking station 1 (step S1).

The fixing hooks 13 and 14 are inserted into the locking holes of the tablet type terminal 2. The fixing button 15 is pressed by the tablet type terminal 2. The sliding member 110 slides, so that the fixing hooks 13 and 14 move from the lock releasing positions to engage with the locking holes of the tablet type terminal 2. According to this, the tablet type terminal 2 is fixed by the fixing hooks 13 and 14 (step S2).

At that time, the sliding member 110 slides, so that the screw protecting member 111 moves to cover the fixing screw 103 (step S3).

Thereafter, the operation of the docking station 1 is branched according to whether the key 11 is used and the antitheft locking mechanism is activated (step S4).

When the antitheft locking mechanism is activated (step S4: YES), the locking part 101 rotates and the locking plate 102 rotates to the position in which this extends from the rotary axis R in the direction toward the locking plate receiving member 112. That is to say, the locking plate 102 moves to the position in which the end in the longitudinal direction is opposed to the locking plate receiving member 112 (step S5).

The releasing button 16 is pressed in this state (step S6). In this case, the locking plate 102 is brought into contact with the locking plate receiving member 112 and the locking plate 102 restricts the sliding of the sliding member 110 (step S7).

According to this, the state in which the tablet type terminal 2 is fixed to the docking station 1 is maintained (step S8).

On the other hand, when the antitheft locking mechanism is not activated (step S4: NO), the releasing button 16 is pressed in this state (step S9). In this case, the sliding member 110 slides and the fixing hooks 13 and 14 move to the lock releasing positions, so that the fixing of the tablet type terminal 2 to the docking station 1 is released (step S10).

At that time, the sliding member 110 slides, so that the screw protecting member 111 moves from the position above the fixing screw 103 (step S11). According to this, the fixing screw 103 may be accessed from outside.

Since the fixing to the docking station 1 is released, the tablet type terminal 2 is removed (step S12).

As described above, in the docking station according to this embodiment, the screw to fix the antitheft locking mechanism to the housing is covered when the antitheft locking mechanism is activated. According to this, when the antitheft lock is fastened, it is difficult to remove the antitheft locking mechanism by disassembling or breaking the docking station. Therefore, it is possible to certainly prevent the electronic device connected to the docking station from being taken away.

The docking station according to this embodiment is subjected to the force to release the fixing of the electronic device on the end of the locking plate as the force in the longitudinal direction of the locking plate. According to this, this may maintain the high strength against the force to release the fixing of the electronic device, so that it is possible to more certainly prevent the electronic device from being taken away.

Furthermore, the docking station according to this embodiment may fasten the antitheft lock of the electronic device without directly fixing the connected electronic device with a cable such as the wire. Therefore, appearance of the docking station to which the electronic device is connected may be made excellent.

An aspect of the function extension device and the electronic device fixing method disclosed by the present application has an effect of certainly preventing the electronic device from being taken away.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A function extension device comprising:
a holding unit that locks to hold an electronic device so as not to be removed when the electronic device is connected and releases the lock such that the electronic device is removed in response to first operation;
a release restricting unit that restricts release of the lock of the holding unit in a state in which the electronic device is connected in response to second operation; and
a preventing unit that prevents contact with a fixing member that fixes the release restricting unit in a locked state by the holding unit.

2. The function extension device according to claim 1, wherein
the preventing unit covers a fixing screw being the fixing member of the release restricting unit with a metal part.

3. The function extension device according to claim 1, wherein
the holding unit includes a locking claw engaged with a locking hole of the electronic device to lock the electronic device and slides to disengage the locking claw from the locking hole to release the lock in response to the second operation in a state in which the electronic device is connected and the locking claw locks the electronic device, and
the release restricting unit restricts the release of the lock by arranging a restricting member in a direction in which the holding unit slides in response to the second operation.

4. The function extension device according to claim 3, wherein
the release restricting unit includes a projection projecting in a first direction orthogonal to the sliding direction and rotatable about a rotary axis extending in the first direction, and the restricting member is a plate-shaped member extending from the projection in a second direction orthogonal to the first direction, the restricting member an end in a longitudinal direction of which is moved to a position opposed to an end in the sliding direction of the holding unit in response to operation to rotate the projection along a plane which has the first direction as a normal as the second operation.

5. An electronic device fixing method comprising:
locking to hold an electronic device so as not to be removed when the electronic device is connected;
releasing the lock such that the electronic device is removed in response to first operation;
restricting release of the lock by a release restricting mechanism in response to second operation; and
preventing contact with a fixing member of the release restricting mechanism in a locked state.
